(19) United States
(12) Patent Application Publication
(10) Pub. No.: US 2015/0008777 A1
(43) Pub. Date: Jan. 8, 2015

(54) SYNCHRONOUS ELECTRIC MACHINE

(71) Applicant: GENRH8, Johannesburg (ZA)

(72) Inventors: Russell Herbert, Johannesburg (ZA); Robert Melaia, Johannesburg (ZA)

(21) Appl. No.: 14/378,960

(22) PCT Filed: Feb. 18, 2013
(86) PCT No.: PCT/ZA2013/000005

§ 371 Date: Aug. 14, 2014

(30) Foreign Application Priority Data
Feb. 16, 2012 (ZA) 2012/01135

(51) Int. Cl. H02K 11/04; H02K 19/26; H02K 19/36; H02K 3/28; H02K 19/12

(52) U.S. Cl. CPC H02K 11/044; H02K 11/046; H02K 3/28; H02K 19/12; H02K 19/36; H02K 19/26
USPC 310/72; 310/68 D

(57) ABSTRACT

This invention relates to a synchronous electric machine including a stator and a rotor, wherein the stator includes a multi-pole stator winding set, the rotor includes a multi-pole cylindrical rotor design or salient pole design with at least two-phase rotor winding set on the cylindrical rotor having the same number of poles as the stator, and the stator windings provide excitation to the rotor by means of stator current imbalance or superimposition, by secondary windings to produce harmonic flux or by a three-phase winding with an external source of excitation. Furthermore, the invention relates to a method for operating a synchronous electric machine.

### FIELD OF THE INVENTION

This invention relates to a synchronous electric machine. More particularly, this invention relates to a controllable-field synchronous electric machine which can be used as a synchronous generator or as a synchronous motor. Furthermore, the invention relates to a method for operating a synchronous electric machine.

### BACKGROUND TO THE INVENTION

It is known in the art that a synchronous electric machine can be used both as a motor and as a generator. While the electric motor is usually described in terms of mechanical terms, i.e. stator and rotor, the electric generator is described from an electrical point of view, i.e. in terms of armature and field. Although different terminology exists, synchronous electric machines can perform bath tasks and are in the following referred to as an electric machine.

The majority of industrial electric motors in use today are asynchronous (induction) types. This is mainly due to the fact that asynchronous motors are simple and rugged compared with synchronous and DC motors. Although the efficiency of a synchronous motor is generally higher than for other industrial electric motor types, synchronous motors are generally complex and expensive to manufacture—largely related to their requirement for a rotating exciter to vary rotor field current. Permanent magnet synchronous motors are simple and less expensive but do not provide any means for controlling the rotor field excitation, which is fixed by the permanent magnets on the rotor. A synchronous machine with variable field excitation—but no rotating exciter—would have the advantages of a synchronous machine without the additional cost and reliability implications that a rotating exciter introduces.

With respect to generators, the majority are controlled using a rotating brushless exciter system. This exciter is mounted on the same shaft/rotor as the main generator rotating components, and forms anything between five percent and thirty percent of the active material and hence cost of a generator. The relative cost of the exciter depends largely on the size or power rating of the generator. In general, the smaller the generator, the higher the relative cost of the exciter.

One example of an electric motor is shown in WO 2007/003868 A1. In this document, an electric motor is described which includes an armature with at least two armature phase pair windings and salient pole rotor arrangement having field windings terminating in a selective electrical switch which determines the electrical continuity of said field windings. Also included is control means which is configured to regulate the magnetizing of the field winding so that, at any given moment, one armature phase pair is usable for magnetizing the field winding whilst the other pair is responsible for torque production.

### SUMMARY OF THE INVENTION

According to a first aspect of the present invention, there is provided a synchronous electric machine including a stator and a rotor, wherein
the stator includes a multi-pole stator winding set,
the rotor includes a multi-pole cylindrical rotor design or a salient pole design with at least two-phase rotor winding set on the cylindrical rotor having the same number of poles as the stator, and
the stator windings provide excitation to the rotor by means of stator current imbalance or superimposition, by secondary windings to produce harmonic flux or by a standard three-phase winding with an external source of rotor field excitation.

According to an embodiment of the invention, the stator current imbalance or superimposition is achieved by an external source, preferably a power supply.

According to a further embodiment of the invention, the excitation of the rotor can be performed by injecting a direct current into the stator windings or into the neutral conductor.

According to a further embodiment of the invention, the excitation of the rotor can be performed by injecting alternating current into the stator windings or into the neutral conductor.

According to a further embodiment of the invention, the stator current imbalance is achieved by a series impedance or resistance in one or more phases of the multi-phase stator winding set.

According to a further embodiment of the invention, the stator current imbalance is achieved by associated control electronics.

According to a further embodiment of the invention, the stator current imbalance is achieved by winding taps at the stator winding set, which can be short-circuited or switched to provide an inherently unbalanced stator winding.

According to a further embodiment of the invention, the stator current imbalance is achieved by a neutral point of one phase having a number of taps which allow shifting the neutral point to create an imbalance.

According to a further embodiment of the invention, the stator current imbalance is achieved by inherently imbalanced windings.

According to a further embodiment of the invention, the number of phases of the multi-phase rotor is two, three, or most preferably four, or more than four.

According to a further embodiment of the invention, the cylindrical rotor is non-salient.

According to a further embodiment of the invention, the machine is capable of operating as a motor.

According to a further embodiment of the invention, the machine is capable of operating as a generator.

According to a further embodiment of the invention, the cylindrical rotor is salient.

According to a further embodiment of the invention, the rectified rotor current is circulated through a main field winding in the rotor, the rotor including both the alternating current excitation winding and a main field winding through which the rectified excitation winding current flows.

According to a further embodiment of the invention, capacitors are added to at least two rotor terminals so as to provide filtering or control actions to improve the performance of the machine.

According to a further embodiment of the invention, the rotor and stator are interchanged with reference to the moving component and the stationary component.

According to a second aspect of the present invention, there is provided a method for operating an electrical machine, which includes the steps of providing a stator and a rotor, wherein the stator includes a multi-pole stator winding set, the rotor includes a multi-pole cylindrical rotor design with an at least two-phase rotor winding set on the cylindrical rotor having the same number of poles as the stator, and the stator windings provide excitation to the rotor by means of stator current imbalance or superimposition, by secondary windings to produce harmonic flux or by a standard three-phase winding with an external source of rotor field excitation.

### DETAILED DESCRIPTION OF THE INVENTION

The invention will now be described in greater detail by way of non-limiting example with reference to the following drawings in which:

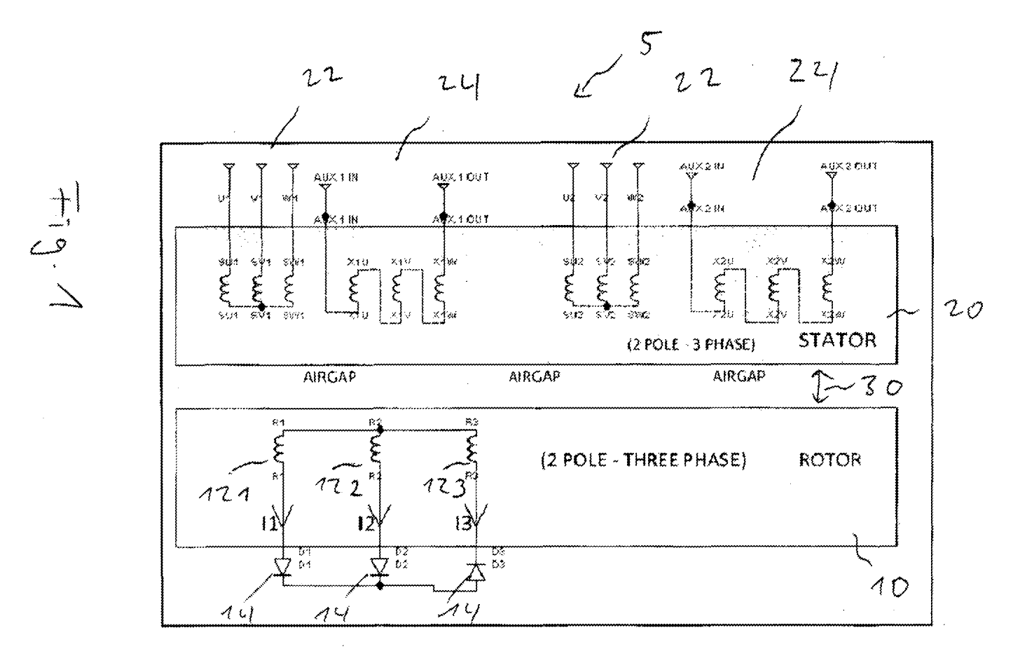

FIG. 1 schematically shows a diagram of an electric machine according to an embodiment of the invention;

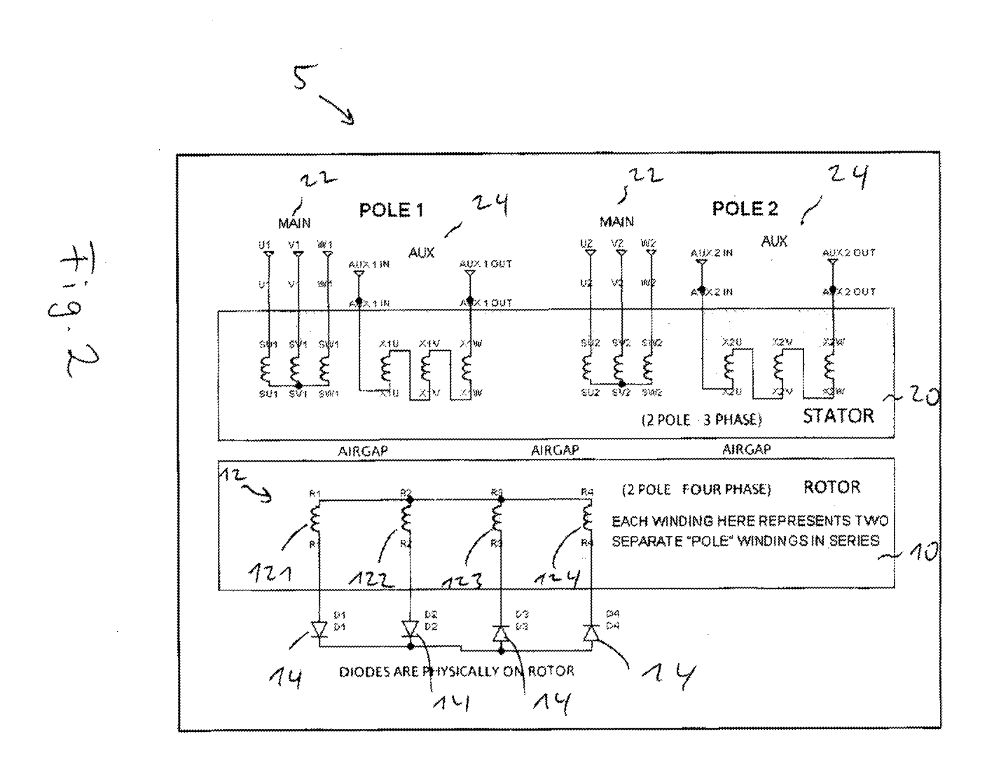

FIG. 2 schematically shows a diagram of an electric machine according to a further embodiment of the invention;

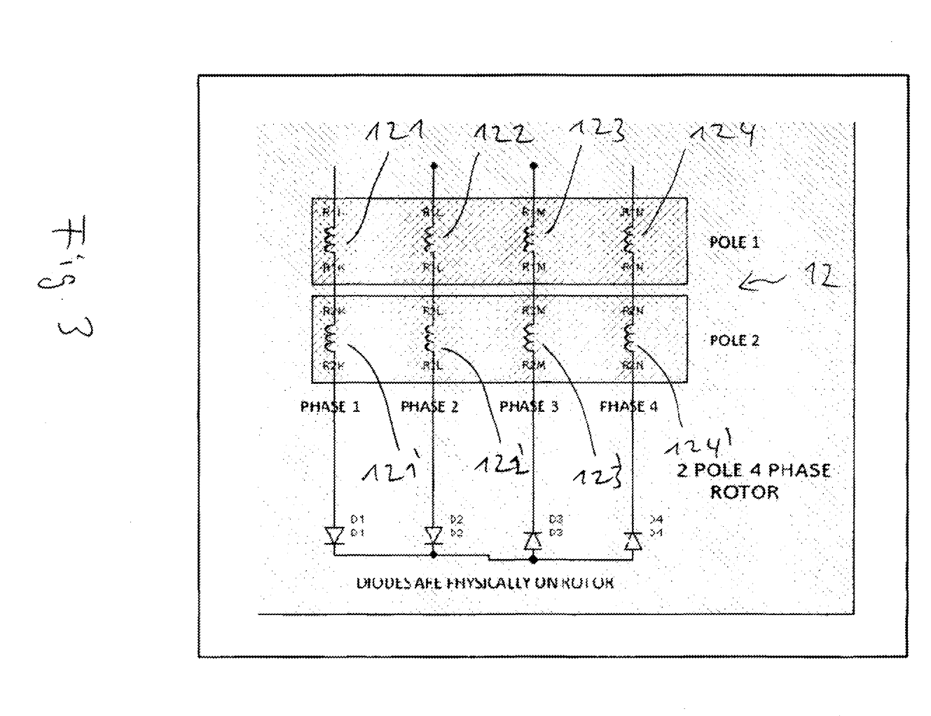

FIG. 3 schematically shows a diagram of an electric machine according to a further embodiment of the invention;

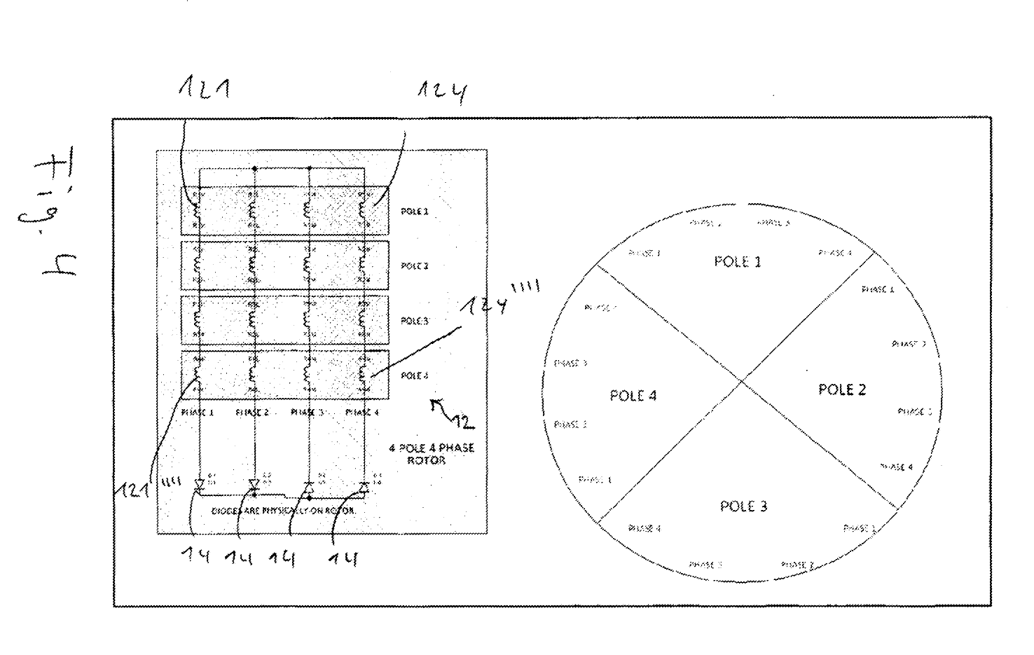

FIG. 4 schematically shows a diagram of an electric machine according to a further embodiment of the invention;

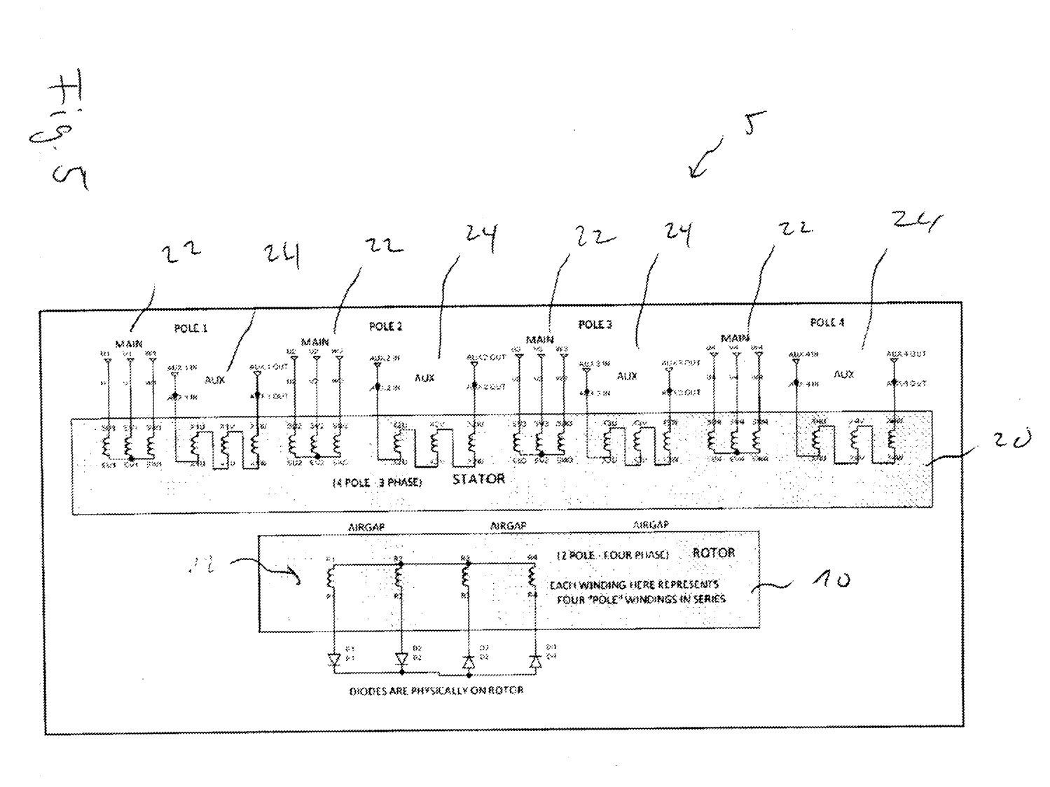

FIG. 5 schematically shows a diagram of an electric machine according to a further embodiment of the invention;

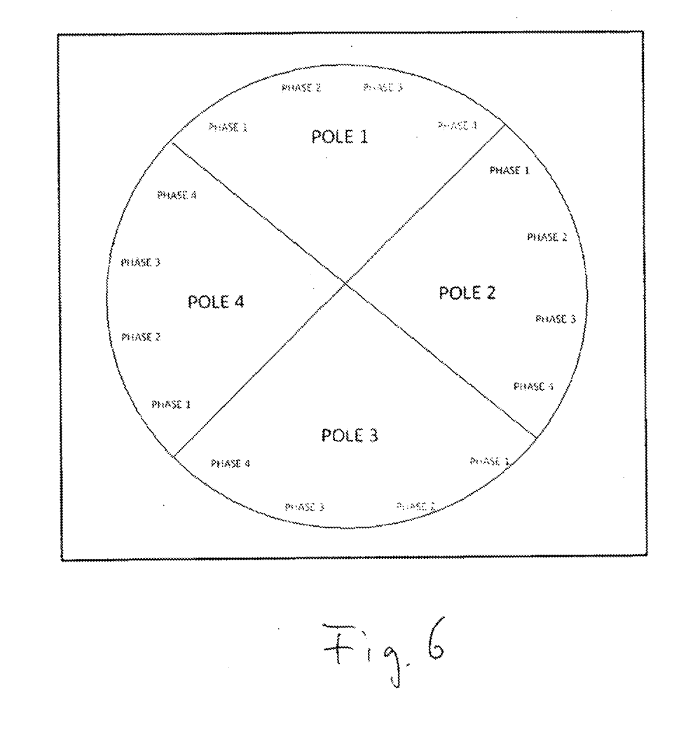

FIG. 6 schematically shows a diagram of an electric machine according to a further embodiment of the invention;

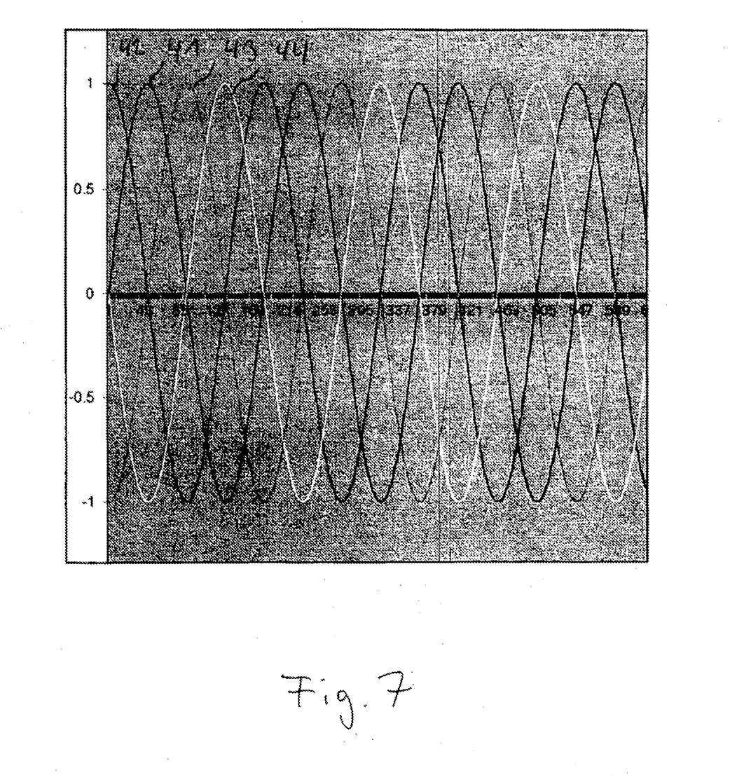

FIG. 7 schematically shows a diagram of winding currents in an embodiment of the invention;

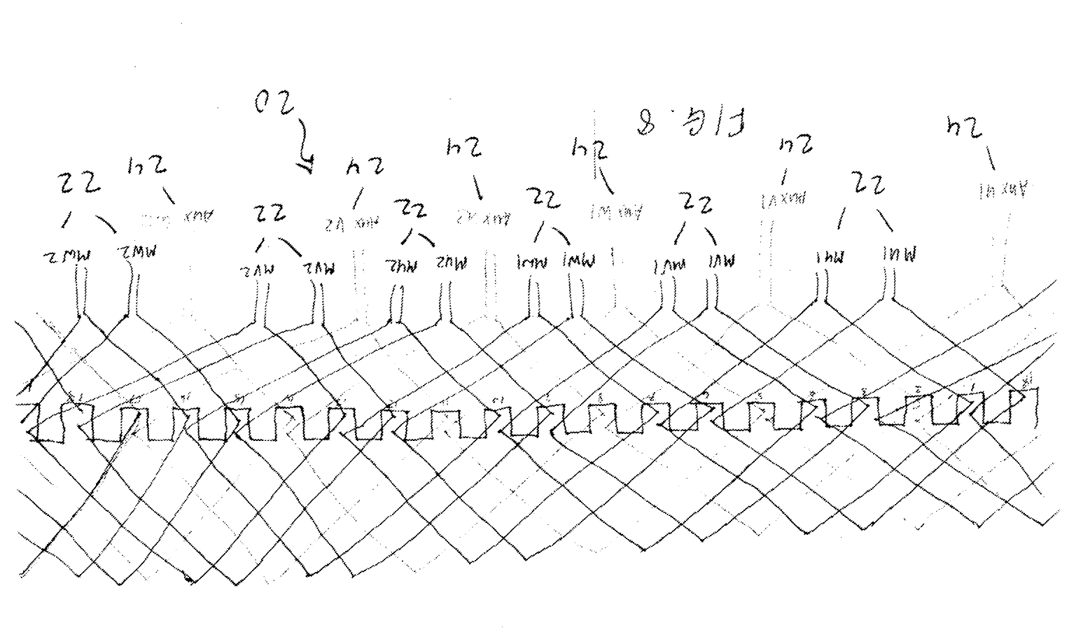

FIG. 8 schematically shows stator windings used in the embodiment of FIGS. 1 to 4 of the invention;

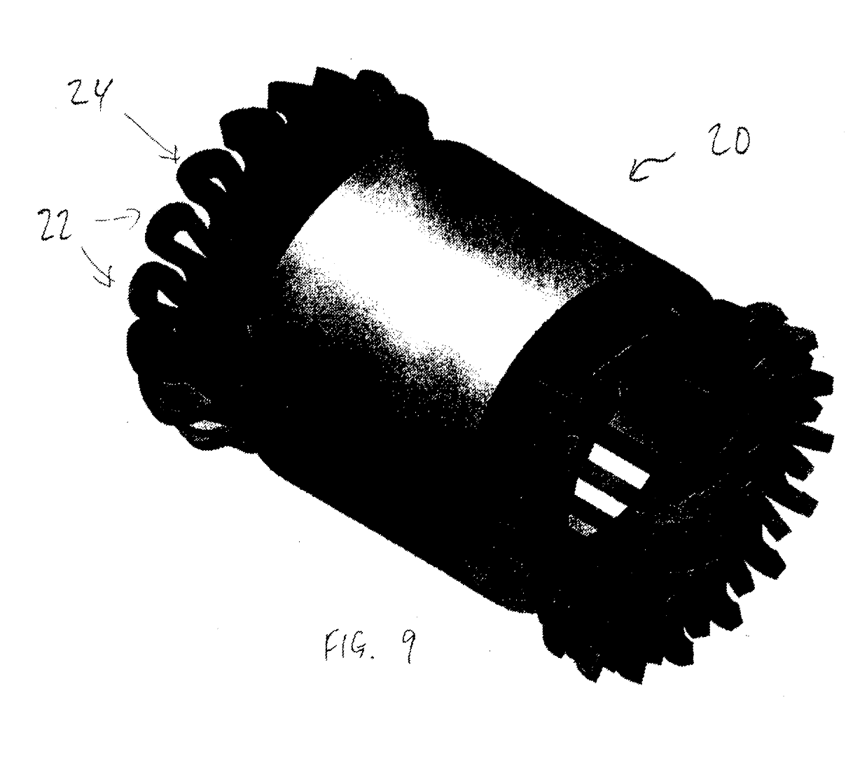

FIG. 9 shows a three-dimensional view of the stator of FIG. 8;

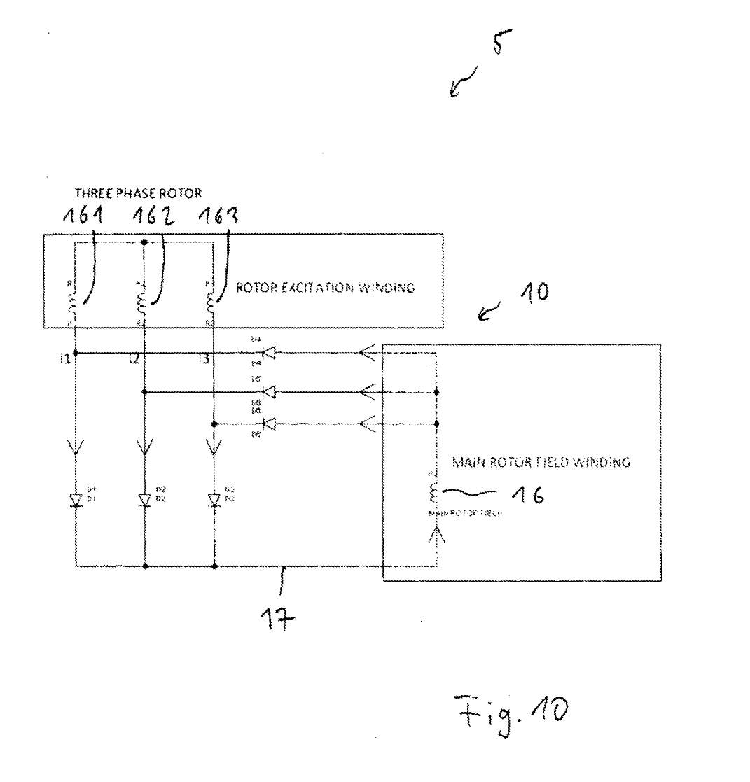

FIG. 10 schematically shows a diagram of an electric machine according to a further embodiment of the invention; and

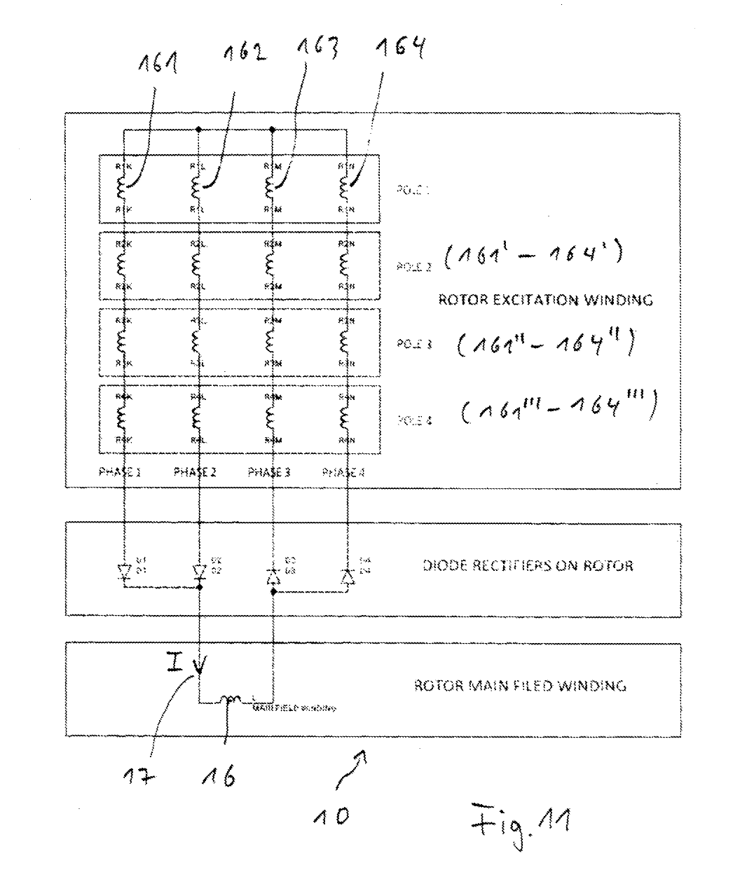

FIG. 11 schematically shows a diagram of an electric machine according to a further embodiment of the invention.

Referring now to the drawings in particular the invention embodied therein includes an electrical machine generally designated with reference numeral 5. In the drawing like reference numerals refer to like parts, unless otherwise indicated.

Making now reference to FIG. 1, a first embodiment of the invention is shown as a schematic diagram. The electrical machine 5 includes a rotor 10. The rotor 10 includes a multi-phase and multi-pole set of rotor windings 12. As depicted in FIG. 1, there are three phases present, which are generated by the three windings 121, 122 and 123. Two of the three windings 121 and 122 are connected in parallel and one winding 123 in an opposite direction of diodes 14 thus generating two poles. The rotor winding 12 is simplified here to illustrate an uneven current distribution through each of the three rotor phases. Current 13 through the one diode 14 associated to winding 123 will be equal to the (negative) sum of I1 and I2, meaning that this winding phase will have to carry twice the current that the other two phases carry.

The stator 20 is a three-phase multi-pole arrangement with two sets of main windings 22 each having three coils 221, 222 and 223 for the three phases and two sets of auxiliary windings 24 each having three coils 241, 242 and 243 to produce harmonic flux to excite the rotor field windings 12. Other modes of excitation will be discussed below. Between rotor 10 and stator 20, an air gap 30 is present.

FIG. 2 shows another embodiment of the electrical machine. Different to FIG. 1, the rotor 10 includes a four-phase winding 12 with windings 121, 122, 123 and 124. The current distribution in the four rotor phases 121 to 124 will be equal, allowing a more practical and less expensive winding. The four phase winding 12 will also allow a much lower harmonic content in the main rotor field current, and it will only require one more diode than the three-phase rotor winding, as discussed above. Please note the simplification of the rotor circuit: each winding in the circuit is actually made up of two series-connected pole windings 12.

Generally speaking, the rotor 10 is a cylindrical rotor design which is not salient although it could be implemented as salient as well. The rotor 10 can be provided as a single, two, three or any multi-phase winding 12 set in slots or otherwise on the cylindrical rotor. The purpose of the cylindrical rotor 10 is—among others—to allow a multi-phase rotor winding 12.

The optimum number of phases is four, for which reasons will be apparent in later sections of this document. The higher the number of phases is, the smoother the rotor field current becomes—irrespective of excitation frequency. This aspect affects the machine performance.

The generator main embodiment is that with a stator 20 with auxiliary windings 24 to supply the induced energy to the rotor field. Depending on the specific nature of the auxiliary stator coils 24 and the rotor field winding 12, there may be very little energy required in the auxiliary coils 24 to excite the rotor field winding 12 to produce full excitation. Please note that the auxiliary stator coils 24 and the rotor field winding 12 behave as a synchronous generator, so the majority of the energy to the rotor field winding can be provided as mechanical energy via a shaft—not as electrical energy from the auxiliary stator windings 24. As such—the auxiliary stator windings 24 themselves can be quite small and of quite thin cross-sectional area.

FIG. 3 shows a detail of a rotor winding for a two pole four-phase rotor 10. The two pole winding 12 is separated into two different slots with windings 121 to 124 and 121′ to 124′ thus achieving the two pole four-phase rotor 10.

FIG. 4 shows on the left hand side a detail of a rotor winding for a four pole four-phase rotor 10. The four pole winding 12 is separated into four different slots with windings 121 to 124 and 121″″ to 124″″ thus achieving the two pole four-phase rotor 10. On the right hand side of FIG. 4, a physical winding layout is shown by depicting the four pole four-phase rotor 10 in a side view.

In FIG. 5 a two pole four-phase rotor 10 is shown together with the stator 20 which is a three-phase four-pole stator with four sets of main windings 22 each having four coils 221, 222, 223 and 224 for the four phases and four sets of auxiliary windings 24 each having four coils 241, 242, 243 and 244.

The corresponding physical winding layout is depicted in FIG. 6, showing a four-pole four-phase rotor 10 in a side view. The stator 20 includes three standard or main phases with the fourth phase representing the auxiliary windings.

In FIG. 7, a diagram of winding current wave forms 41 to 44 as a function of the phase angle is shown. A prior art single-phase design would have rotor current approximately following the positive portion of only winding current 41. In other words, winding current would only flow between 0 and 85 degrees, 169 and 253 degrees (horizontal scale), and so on—with zero current in between these portions. The four-phase winding current would follow the top contour/envelope of all four waves: wave 42 from 0 to approx. 21 degrees, wave 41 from 21 to 65 degrees, wave 43 from 65 to approx. 110 degrees, and wave 44 from 110 to 150 degrees and then wave 42 again.

It is not difficult to appreciate that with the same filtering/smoothing action of the inductive rotor circuit, that the rotor current will be drastically smoother than the prior art with such a four-phase winding 12. The advantage is so significant that a DC-current can be used in the auxiliary windings 24 for generators, without any significant harmonic effects.

In general, it will be absented from the rotor current waveform for a four-phase rotor that the operation of this machine 5 as either a generator or motor becomes much more attractive with the multi-phase rotor 20. A variable speed drive firmware in associated control electronics and a design to drive the motor embodiment will be considerably simplified because a low frequency superimposed waveform 41 to 44 may be used—even a direct current. excitation on the stator 20.

The importance of an unbalanced stator 10 operation relates to the possibility of implementing a form of stator 20 unbalance in the machine 5 (generator or motor) design itself.

The embodiments considered are stator windings 22 with taps at certain points in the winding, which can be short-circuited or switched to provide an inherently unbalanced stator winding. Another embodiment could be a stator winding 22 in which one or more phases has less or more turns than the other phases. Although this design will not allow variation of the imbalance—it may allow a wide range of practical synchronous excitation operation in an extremely simple design. Another embodiment could be a design in which the neutral point of one phase has a number of taps which allow “shifting” the neutral point so that it creates an imbalance. Depending on the number of taps and their relative displacement in the winding—this could allow a wide range of controllable excitation.

Accordingly, the following embodiments all rely on stator current imbalance or superimposition. This can be achieved by external means, i.e. a power supply, series impedance or resistance in one or more phases, or the associated control electronics or by internal means, i.e., winding taps, shifting neutral, inherently imbalanced winding etc.

In a first embodiment, the excitation of the rotor 10 can be achieved by injecting direct current (DC) into the stator windings 22. The simplest way to implement this is to inject DC into the neutral circuit. This will have the same effect as the auxiliary windings 24 at a very much reduced complexity.

In a second embodiment, the excitation of the rotor 10 can be achieved by injecting alternating current into the stator 20. In the same way as a direct current superimposed on the stator 20 via the neutral conductor can excite the rotor 10, an alternating current (AC) can be used as well. This will also be implemented in the same way as described above, by injecting current into the neutral conductor. This embodiment is more suitable for a motor than a generator and will greatly improve motor performance at lower speeds.

In a second embodiment, the auxiliary windings 24 can be excited with AC or DC. Although DC will be best for generators and AC for motors—both are included as embodiments for both motors and generators.

The multi-phase or poly-phase rotor winding 12, and cylindrical rotor construction allows much smoother rotor field current than in any other single-phase implementations, effectively allowing DC to be used in the auxiliary windings 24, without a significant degradation in generator or motor performance. It must be noted that the presence of harmonics in the rotor current will not only affect the torque or power of the generator or motor. These would otherwise increase the losses in the machine and hence affect load ratings and of course efficiency.

The optimum number of phases of the rotor winding 12 has been discussed and is considered to be four. However—if AC is used for the excitation of the auxiliary windings 12 or the superimposition of the field winding power then two phases will provide smooth enough field current to be considered optimum. In the last embodiment the cost is lower because of only two diodes and less connections.

The cylindrical rotor 10 construction is less expensive. It is easier and less expensive to mass produce and will allow more effective use to be made of the slot area and hence the rotor copper. More rotor 10 copper will of course allow higher efficiency for the same size machine 5. Cylindrical rotor construction will also cause no saliency torque—leaving torque production only to the rotor field winding 12.

It is of course possible to implement this design using a salient pole rotor construction, specifically with the same auxiliary coil arrangement 24 as discussed above, but there is limited advantage to the multi-phase rotor windings 12 for salient pole rotor construction as the rotor coils need to be arranged in multiple phases, being distributed across more than one pole—so coils will have to bridge the neutral area between poles.

The most important design features of the above discussed concept are the cylindrical rotor multi-phase winding 12, and the three-phase series-connected auxiliary windings 24. The advantages of the multi-phase rotor have already been described in terms of the radically smoother rotor field current and consequential improvement in performance of both motor or generator operation—but particularly relevant to generators. The advantage of the series-connected three-phase auxiliary winding 24 is that this arrangement negates any induced electromotive force or voltage on these windings 24 due to the same generator action that will induce electromotive force on the main stator windings 22. Without this invention, the use of auxiliary windings 24 would be almost impossible because of the large-magnitude electromotive force that will be induced in these windings. The principle of cancellation is based on the simple rule of three-phase distributed windings that V1+V2+V3=0, in other words—the arithmetic sum of the three phase voltages is equal to zero. As the phase angle is not relevant for the incoming supply, the three phase winding electromotive force vectors all act in the same direction, to provide the crucial electromotive force required to excite the rotor field windings.

Making now reference to FIG. 8, a further embodiment of the invention is shown. In this embodiment the stator 20 winding is outlined in more detail. As mentioned above with respect to FIGS. 1 to 4, the stator 20 includes multi-pole and multi-phase main stator windings 22 and auxiliary stator windings 24. In FIG. 8, the main stator windings 22 of stator 20 are respectively labelled MU, MV, and MW for each phase. For each pole of stator 20 the main stator windings 22 of stator 20 are labelled by adding the respective pole number to MU, MV, and MW. Accordingly, MU1 denotes the first phase, first pole winding within the main stator windings 22, MW2 denotes the third phase, second pole winding within the main stator windings 22. A similar naming scheme is deployed for the stator auxiliary windings 24. AUXU1, AUXV1 and AUXW1 denote a respective sub-coil of the first pole stator auxiliary windings 24. As depicted in FIG. 8, the main stator windings 22 and the stator auxiliary windings 24 are arranged in a regular pattern, wherein each of the sub coil windings also spans into the neighbouring windings. The stator auxiliary windings 24 do not need to be the same size as the main stator windings 22.

A three-dimensional view of the stator 20 of FIG. 8 is shown in FIG. 9. The stator 20 forms a compact design of the main stator windings 22 and of the stator auxiliary windings 24 and can be used in connection with the electrical machine as outlined in the previous embodiments.

Making now reference to FIG. 10, a further embodiment of the invention is shown. FIG. 10 schematically shows a diagram of the electric machine 5 with rotor 10 having three phases. The rotor 10 includes a main field winding 16 and three rotor excitation windings 161, 162 and 163. The rectified current 17 from the rotor excitation windings 161, 162 and 163 is directed through the main field winding 16 on the rotor 10.

In this embodiment, the rectified rotor current 17 is circulated through the main field winding 16 in the rotor 10. The rotor 10 therefore includes both the alternating current excitation winding according to the previous embodiments, as well as the main field winding 16 through which the rectified excitation winding current flows.

The excitation winding on the stator 20 and the excitation winding on the rotor 10 may have any number of phases—different or equal to each other, to suit the performance requirements. In other words—the number of phases of the excitation winding on the stator 20 and rotor 10 do not have to be equal, but they can be equal if desired.

The excitation winding on the stator 20 and the rotor 10 will typically have the same number of poles as each other, but these may be different.

The excitation winding on the stator 20 and the rotor 10 will typically have different numbers of poles as the main stator winding or the main rotor field winding 16. but these may be chosen as needed in a specific embodiment.

In a further embodiment, as depicted in FIG. 11, an electric machine 5 with four phases and four poles on the rotor 10 is shown. Similar to the previous embodiment of FIG. 10, the rectified current 17 from the rotor excitation winding is directed through the main field winding 16 on the rotor 10. The rotor excitation includes four times four rotor excitation windings 161, 162. 163 and 164 to 161′″, 162′″, 163′″ and 164′″ so as to form the four phases and four poles.

It should be mentioned that capacitors (not shown in FIG. 10 or FIG. 11) can be added to at least two rotor terminals so as to provide filtering or control actions to improve the performance of the machine 5.

Furthermore, the rotor 10 and stator 20 can be interchanged with reference to the moving component and the stationary component, which is known in the art as an “inverted” design.

Although certain embodiments only of the invention have been described herein, it will be understood by any person skilled in the art that other modifications, variations, and possibilities of the invention are possible. Such modifications, variations and possibilities are therefore to be considered as falling within the spirit and scope of the invention and hence forming part of the invention as herein described and/or exemplified.

This invention having been described in its preferred embodiment, it is clear that it is susceptible to numerous modifications and embodiments within the ability of those skilled in the art and without the exercise of the inventive faculty. Accordingly, the scope of the invention is defined by the scope of the following claims.

1. A synchronous electric machine including a stator and a rotor, wherein
the stator includes a multi-pole stator winding set,
the rotor includes a multi-pole cylindrical rotor design or a salient pole design with at least two-phase rotor winding set on the cylindrical rotor having the same number of poles as the stator, and
the stator windings provide excitation to the rotor by means of stator current imbalance or superimposition, by secondary windings to produce harmonic flux or by a three-phase winding with an external source of excitation,
wherein each of the rotor windings of the rotor winding set includes a diode and said diodes are connected either parallel or anti-parallel to each other so as to generate the respective number of poles.

2. The electrical machine according to claim 1, wherein the stator current imbalance or superimposition is achieved by an external source, preferably a power supply.

3. The electrical machine according to claim 2, wherein the excitation of the rotor is performed by injecting a direct current into the stator windings.

4. The electrical machine according to claim 2, wherein the excitation of the rotor is performed by injecting alternating current into the neutral conductor.

5. The electrical machine according to claim 1, wherein the stator current imbalance is achieved by a series impedance or resistance in one or more phases of the multi-phase stator winding set.

6. The electrical machine according to claim 1, wherein the stator current excitation is achieved by associated control electronics such as a variable speed drive.

7. The electrical machine according to claim 1, wherein the stator current imbalance is achieved by winding taps at the stator winding set, which can be short-circuited or switched to provide an inherently unbalanced stator winding.

8. The electrical machine according to claim 1, wherein the stator current imbalance is achieved by a neutral point of one phase having a number of taps which allow shifting the neutral point to create an imbalance.

9. The electrical machine according to claim 1, wherein the stator current imbalance is achieved by inherently imbalanced windings.

10. The electrical machine according to claim 1, wherein the number of phases of the multi-phase rotor is two, three, preferably four or more than four.

11. The electrical machine according to claim 1, wherein the cylindrical rotor is salient or non-salient.

12. The electrical machine according to claim 1, wherein the machine is capable of operating as a generator.

13. The electrical machine according to claim 1, wherein the machine is capable of operating as a motor.

14. The electrical machine according to claim 1, wherein the rectified rotor current is circulated through a main field winding in the rotor, the rotor including both the alternating current excitation winding and a main field winding through which the rectified excitation winding current flows.

15. The electrical machine according to claim 14, wherein capacitors are added to at least two rotor terminals so as to provide filtering or control actions to improve the performance of the machine.

16. The electrical machine according to claim 14, wherein the rotor and stator are interchanged with reference to the moving component and the stationary component.

17. The electrical machine according to claim 1, wherein the stator winding set is provided having one or more phases with less or more turns than the other phases so as to provide an inherently unbalanced stator winding.

18. A method for operating an electrical machine, which includes: providing a stator and a rotor, wherein the stator includes a multi-pole stator winding set, the rotor includes a multi-pole cylindrical rotor design or a salient pole design with at least two-phase rotor winding set on the cylindrical rotor having the same number of poles as the stator, and the stator windings provide excitation to the rotor by means of stator current imbalance or superimposition, by secondary windings to produce harmonic flux or by a standard three-phase winding with an external source of excitation, wherein each of the rotor windings of the rotor winding set includes a diode and said diodes are connected either parallel or anti-parallel to each other so as to generate the respective number of poles.

19. (canceled)

20. (cancelled)

21. (cancelled)

22. (canceled)
